(19) United States
(12) Patent Application Publication
(10) Pub. No.: US 2026/0307599 A1
(43) Pub. Date: Oct. 8, 2026

(54) FRONT VEHICLE BODY STRUCTURE

(71) Applicants: Kia Corporation, Seoul (KR); Hyundai Motor Company, Seoul (KR)

(72) Inventors: Jejoon Lee, Hwaseong-si (KR); Jiae Yong, Hwaseong-si (KR); Seongjae Lee, Hwaseong-si (KR); Chulhee Heo, Hwaseong-si (KR); Hae Hoon Lee, Hwaseong-si (KR)

(21) Appl. No.: 19/565,023

(22) Filed: Mar. 12, 2026

(30) Foreign Application Priority Data
Apr. 2, 2025 (KR) 10-2025-0042557
Jul. 10, 2025 (KR) 10-2025-0092911

(51) Int. Cl. B60R 13/10

(52) U.S. Cl. CPC B60R 13/10

(57) ABSTRACT

A front vehicle body structure may include a dash panel, a windshield, a front cowl assembly connected to the dash panel, and a vehicle identification number (VIN) unit disposed inside the windshield and connected to an upper part of the front cowl assembly. A vehicle may be configured as a purpose built vehicle (PBV) including a front body module permanently fixed at a front part of the vehicle, and a rear body module configured as a replaceable portion removably couplable with the front body module, wherein the rear body module is removably coupled at a rear part of the vehicle, and the front body module may include the dash panel, the front cowl assembly, the windshield, and the VIN unit.

### CROSS-REFERENCE TO RELATED APPLICATIONS

This application claims priority to and the benefit of Korean Patent Application No. 10-2025-0042557 filed with the Korean Intellectual Property Office on Apr. 2, 2025, and Korean Patent Application No. 10-2025- 0092911 filed with the Korean Intellectual Property Office on Jul. 10, 2025, the entire contents of which are incorporated herein by reference.

### TECHNICAL FIELD

The present disclosure relates to a vehicle body structure.

### BACKGROUND

Recently, the automotive industry has been introducing a new concept of future mobility vision for realizing a human-centric dynamic future city. One of these future mobility solutions is a Purpose Built Vehicle (PBV) as a Purpose Built Mobility.

A PBV can be exemplified by an eco-friendly mobile vehicle based on an electric vehicle (EV). Such a PBV can provide various customized services to a user, for example, during the time spent moving from a starting point to a destination.

PBVs can be manufactured in various shapes and sizes according to a user’s purpose of use and use cases.

For example, a PBV can be utilized as a hailing type (or passenger van type) vehicle in which cabins are respectively configured at a front part and a rear part of a vehicle body. For example, a PBV may be utilized as a cargo type vehicle (commonly referred to by those skilled in the art as a delivery type, cargo van type, or chassis cab type) in which a cabin is configured at the front part of the vehicle body and a cargo assembly is configured at the rear part of the vehicle body.

A vehicle identification number (VIN) (or chassis number) is engraved at a set position of a vehicle body. A vehicle identification number refers to a unique identification number of a vehicle for providing information on the vehicle. In Korea, Europe, and North America, the engraving of a vehicle identification number is mandated by regulation.

To prevent forgery and tampering, such a vehicle identification number must be engraved on a vehicle body structure such as a chassis and a frame, not a bolted component, by regulation. Accordingly, in most vehicles, a VIN engraving part is located on a seat cross member in a cabin, a front cowl at a front part of a vehicle body, a fender apron, and the like.

In an example of a PBV, because a seat cross member may be disposed outdoors to maximize indoor space, it is not easy to locate a VIN engraving part on the seat cross member.

In an example of a PBV, because the indoor space changes according to a user’s purpose of use, it is not easy to locate a VIN engraving part at the same position in vehicle bodies of various vehicle types.

Furthermore, in an example of a PBV, because the size of a power electronics (PE) room provided at the front part of the vehicle body is minimized to secure a wide indoor space, it is also not easy to locate a VIN engraving part inside the PE room.

Recently, body swappable vehicles that can be easily changed into various types of vehicle bodies have been provided to increase the utility of PBVs.

In an example of such a body swappable vehicle, because a replaceable portion of the rear part of the vehicle body is detachable, if a VIN engraving part is located on the replaceable portion, there is a possibility of violating regulations for preventing forgery and tampering of the vehicle identification number.

The matters described in this background section are to enhance the understanding of the background of the present disclosure and may include matters that are not prior art already publicly known, available, or in use.

### SUMMARY

Some embodiments of the present disclosure relate to a vehicle body structure, and more specifically, to a front vehicle body structure applicable to the production of various types of vehicle bodies, such as Purpose Built Vehicles (PBVs).

The disclosed example embodiments may provide a front vehicle body structure capable of satisfying various regulatory requirements of vehicle identification number regulations.

A front vehicle body structure, according to some embodiments of the present disclosure, may include a front cowl assembly connected to a dash panel, and a VIN unit disposed inside a windshield connected to the front cowl assembly and connected to an upper part of the front cowl assembly.

The front cowl assembly may include a cowl top panel connected to an upper part of the dash panel, and a cowl lower panel disposed below the cowl top panel and connected to the dash panel.

The VIN unit may include a VIN engraving bracket connected to the cowl top panel and having a VIN engraving part formed at a position corresponding to a lower part of the windshield.

The VIN engraving bracket may be connected to a lower part of the cowl top panel and extend from the lower part of the cowl top panel in an inclined direction of the windshield.

The VIN engraving bracket may extend from the lower part of the cowl top panel in an inclined direction of the windshield, and the VIN engraving part may be formed on an extending portion of the VIN engraving bracket.

The VIN engraving part may be exposed to the outside through a slit formed along a vehicle width direction in an opaque film coated on a lower edge of the windshield.

The VIN engraving part may be exposed to the outside through a slit formed along a vehicle width direction in an opaque film coated on a lower edge of the windshield, and a cowl lower reinforcement panel may be connected to the cowl lower panel, and the slit may be covered by a wiper part mounted on the cowl lower reinforcement panel.

The VIN unit may include a VIN engraving bracket connected to the cowl top panel and having a VIN engraving part formed at a position corresponding to a lower part of the windshield, and a cowl connection reinforcement bracket connected to the VIN engraving bracket and connected to an upper part of the cowl lower panel.

The VIN engraving bracket may include a first portion connected to the lower part of the cowl top panel and the cowl connection reinforcement bracket by triple-layer welding, and a second portion extending from the first portion along the inclined direction of the windshield and having the VIN engraving part formed thereon.

The cowl connection reinforcement bracket may be provided in a “Z” cross-sectional shape.

The VIN engraving bracket may be connected to the lower part of the cowl top panel, and a windshield sealer application line may be formed along the vehicle width direction on the upper part of the cowl top panel.

The front cowl assembly may further include a cowl lower reinforcement panel connected to the cowl lower panel, and at least one bulkhead connected between the cowl top panel and the cowl lower panel.

The cowl lower reinforcement panel may be bolt-connected to the cowl lower panel in a vehicle longitudinal direction.

The dash panel and the front cowl assembly may be provided as a front body module as a fixed portion forming a cabin at a front part of a vehicle body, and a rear body module as a replaceable portion selectively couplable with the front body module may be provided at a rear part of the vehicle body.

For a front vehicle body structure according to some embodiments of the present disclosure, various legal requirements stipulated in the vehicle identification number regulations can be satisfied, and the connecting stiffness between the front cowl assembly and the VIN engraving bracket can be strengthened.

Other advantages obtainable or predicted due to the disclosed example embodiments will be disclosed directly or implicitly in the detailed description of the disclosed example embodiments. That is, various advantages predicted according to the disclosed example embodiments may be disclosed in the detailed description to be described later.

### BRIEF DESCRIPTION OF THE DRAWINGS

Because these drawings are for reference in explaining the disclosed example embodiments, technical ideas of the present disclosure is not necessarily limited to the accompanying drawings.

FIG. 1 is a side view showing a front vehicle body structure according to a disclosed example embodiment of the present disclosure.

FIG. 2 is a perspective view showing a front vehicle body structure according to a disclosed example embodiment of the present disclosure.

FIG. 3 is an exploded perspective view showing a front vehicle body structure according to a disclosed example embodiment of the present disclosure.

FIG. 4 is a cross-sectional view showing a front vehicle body structure according to a disclosed example embodiment of the present disclosure.

FIG. 5 is a perspective view showing a front cowl assembly and a VIN unit applied to a front vehicle body structure according to a disclosed example embodiment of the present disclosure.

FIG. 6 is a partially exploded perspective view showing a front cowl assembly and a VIN unit applied to a front vehicle body structure according to a disclosed example embodiment of the present disclosure.

FIGS. 7 and 8 are perspective views showing a VIN unit applied to a front vehicle body structure according to a disclosed example embodiment of the present disclosure.

FIG. 9 is a side view showing a VIN unit applied to a front vehicle body structure according to a disclosed example embodiment of the present disclosure.

FIG. 10 is a perspective view showing a VIN engraving bracket of a VIN unit configured to be applied to a front vehicle body structure according to a disclosed example embodiment of the present disclosure.

FIG. 11 is a perspective view showing a cowl connection reinforcement bracket of a VIN unit configured to be applied to a front vehicle body structure according to a disclosed example embodiment of the present disclosure.

FIG. 12 is a view showing a windshield sealer application line applied to a front vehicle body structure according to a disclosed example embodiment of the present disclosure.

FIG. 13 is a cross-sectional view for explaining an operation of a front vehicle body structure according to a disclosed example embodiment of the present disclosure.

The above-referenced drawings are not necessarily shown to scale and may be understood to present a somewhat simplified representation of various features illustrating some principles of the disclosed example embodiments. For example, specific design features of the disclosed example embodiments including specific dimensions, orientations, locations, and shapes may be determined in part by the specific intended application and use environment.

### DETAILED DESCRIPTION OF ILLUSTRATIVE EMBODIMENTS

Next, the disclosed example embodiments will be described in detail with reference to the accompanying drawings so that those skilled in the art to which the present invention pertains can easily implement them. However, embodiments of the present disclosure may be implemented in many different forms for other embodiments and the present disclosure is not necessarily limited to the example embodiments described herein.

Terminology used herein is for the purpose of describing specific example embodiments and is not intended to be necessarily limiting of the present disclosure. As used herein, singular forms may include the plural forms as well, unless the context clearly indicates otherwise.

It may be further understood that the terms “includes” and/or “comprises” when used in this specification specify the presence of stated features, integers, steps, operations, elements, and/or components, but do not preclude the presence or addition of one or more other features, integers, steps, operations, components, and/or groups thereof.

As used herein, the term “and/or” includes any one or all combinations of one or more of the associated listed items.

In this specification, the term “connected” indicates a physical relationship between two components where the components are directly connected to each other by bolts, nuts, rivets, FDS (Flow Drill Screw), structural adhesives, or the like, or indirectly connected through one or more intermediate components.

In some embodiments, “vehicle,” “vehicle’s,” “automobile,” or other similar terms as used herein may include passenger automobiles including passenger cars, sport utility vehicles (SUV), buses, trucks, tractors, various commercial vehicles, and may include hybrid vehicles, electric vehicles, hybrid electric vehicles, electric vehicle-based PBVs (Purpose Built Vehicles), hydrogen-powered vehicles, and other alternative fuel vehicles (e.g., fuels derived from resources other than petroleum), for example.

Next, disclosed example embodiments will be described in detail with reference to the accompanying drawings.

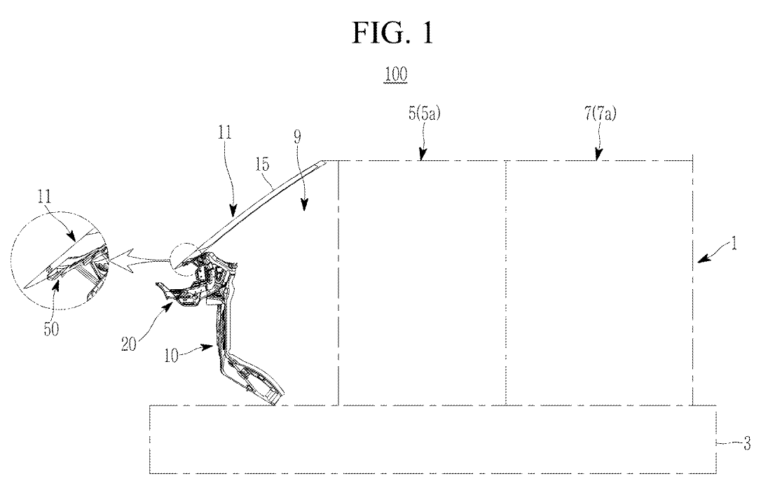

FIG. 1 is a side view showing a front vehicle body structure according to a disclosed embodiment.

Referring to FIG. 1, a front vehicle body structure 100 according to a disclosed example embodiment may be applied to, for example, a vehicle body 1 of a Purpose Built Vehicle (hereinafter, referred to as “PBV”).

In some embodiments, the PBV may be utilized as an electric vehicle-based life module vehicle that provides various customized services to a user during a time spent moving from a starting point to a destination. The vehicle body 1 of such a PBV may be manufactured in various shapes and sizes according to the purpose of use of the PBV.

In some embodiments, the vehicle body 1 of the PBV may be utilized for vehicles of various vehicle types. In one example, the vehicle body 1 of the PBV may be utilized as a hailing type (or passenger van type) vehicle in which cabins are respectively configured at a front part and a rear part.

In another example, the vehicle body 1 of the PBV may be utilized as a cargo type vehicle (commonly referred to by those skilled in the art as a delivery type or a cargo van type) in which a cabin is configured at the front part and a cargo is configured at the rear part.

In this specification, a reference direction for describing the following components may be set as a vehicle longitudinal direction (e.g., a vehicle body length direction or longitudinal direction), a vehicle width direction (e.g., a left-right direction or transverse direction), and a vertical direction (e.g., a height direction) based on the vehicle body, for example.

In this specification, an “upper end part”, “upper part”, “upper end”, or “upper surface” of a component may indicate an end, part, portion, or surface of a component relatively on the upper side in the drawings, and a “lower end part”, “lower part”, “lower end”, or “lower surface” of a component may indicate an end, part, portion, or surface of a component relatively on the lower side in the drawings.

In this specification, an end (e.g., one end, the other end, or both ends, etc.) of a component may indicate an end of the component in any one direction, and an end part (e.g., one end part, the other end part, both end parts, a front end part, or a rear end part, etc.) of a component may indicate a certain part of the component including the end.

In some embodiments, the vehicle body 1 of the PBV may include an underbody 3, a front body module 5 assembled to a front part of the underbody 3, and a rear body module 7 assembled to a rear part of the underbody 3.

In some embodiments, the front body module 5 may be configured to form a front cabin 9 at the front part of the vehicle body 1.

In some embodiments, the front body module 5 may be provided as a fixed portion 5a fixed to the front part of the underbody 3.

In some embodiments, the front body module 5 may be fixed to the front part of the underbody 3 along the vertical direction through a vehicle body mounting unit known to those skilled in the art. In some embodiments, the fixed portion 5a may be defined as a configuration that is not replaced even if the purpose of use of the PBV is changed in the disclosed embodiments and claims.

In some embodiments, the rear body module 7 may be configured to form a rear cabin, a cargo room (or luggage room), a deck, and the like at the rear part of the vehicle body 1.

In some embodiments, the rear body module 7 may be provided as a replaceable portion 7a connected to the rear part of the underbody 3 and the rear part of the front body module 5.

In some embodiments, the rear body module 7 may be connected to the rear part of the underbody 3 and the rear part of the front body module 5 by a joint unit, or may be separated from the rear part of the underbody 3 and the rear part of the front body module 5.

In some embodiments, the rear body module 7 may be manufactured in various shapes according to the purpose of use and use cases of the PBV. In some embodiments, the replaceable portion 7a may be defined as a configuration that is selectively replaceable according to the purpose of use and use cases of the PBV in the disclosed embodiments and claims.

In some embodiments, the joint unit as described above may be, for example, a configuration for connecting in various forms, such as a configuration for manually connecting with a mechanical configuration, a configuration for connecting by the operation of a separate actuator, and a configuration that can be connected and/or released according to the supply of external or internal power including a magnet or the like. The configuration and operation of the joint unit for connecting or releasing one or more modules or frames may be apparent to those skilled in the art, and thus detailed descriptions thereof will be omitted.

In some embodiments, the front vehicle body structure 100 may be configured to satisfy the vehicle identification number regulations of Korea, Europe, and North America, for example.

In some embodiments, a vehicle identification number (VIN) (or chassis number) is a unique identification number of a vehicle for providing information on the vehicle, and may be engraved (or stamped) on the vehicle body 1 by a combination of letters and numbers.

The vehicle identification number regulations may stipulate matters such as protecting the vehicle identification number to prevent forgery and tampering, having to engrave the vehicle identification number on a vehicle body structure that is not removable, and having to ensure visibility of the vehicle identification number.

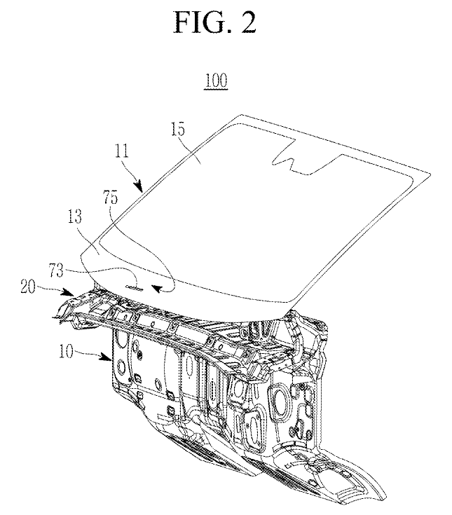

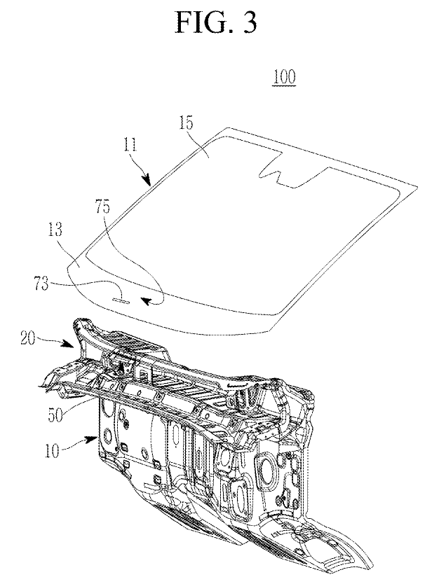

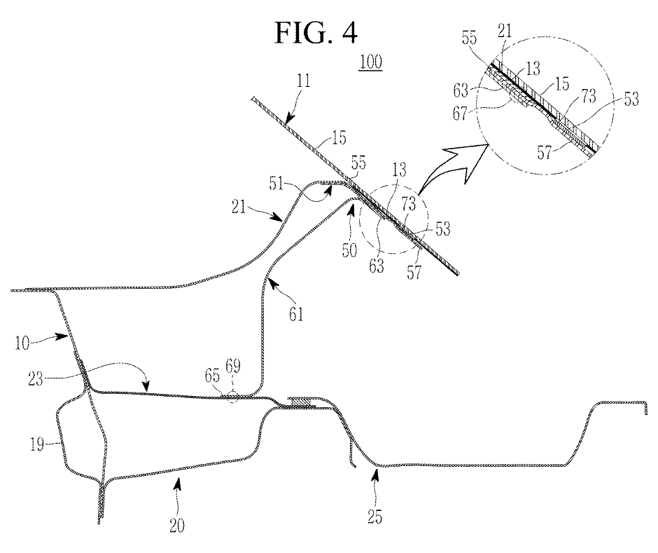

FIG. 2 is a perspective view showing a front vehicle body structure according to a disclosed example embodiment. FIG. 3 is an exploded perspective view showing a front vehicle body structure according to a disclosed example embodiment. FIG. 4 is a cross-sectional view showing a front vehicle body structure according to a disclosed example embodiment.

Referring to FIGS. 2-4 , in some embodiments, a front vehicle body structure 100 may include a front cowl assembly 20 and a VIN unit 50 provided in the front body module 5.

In some embodiments, the front cowl assembly 20 may be disposed in the front body module 5 along the vehicle width direction. The front cowl assembly 20 may be connected to a dash panel 10 provided in the front body module 5.

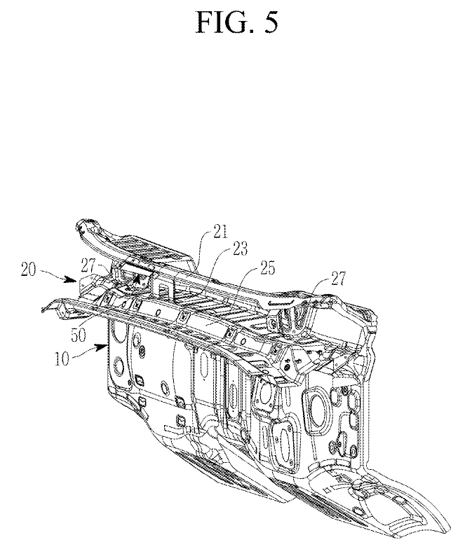

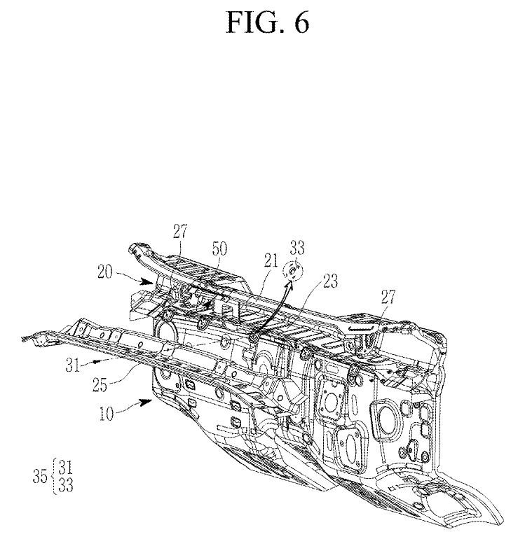

FIG. 5 is a perspective view showing a front cowl assembly and a VIN unit applied to a front vehicle body structure according to a disclosed example embodiment. FIG. 6 is a partially exploded perspective view showing a front cowl assembly and a VIN unit applied to a front vehicle body structure according to a disclosed example embodiment.

In some embodiments, the front cowl assembly 20 may include, as illustrated in FIGS. 5 and 6 , a cowl top panel 21, a cowl lower panel 23, a cowl lower reinforcement panel 25, and at least one bulkhead 27.

In some embodiments, the cowl top panel 21 may be connected to the upper part of the dash panel 10. The cowl top panel 21 may be connected to a windshield 11. Typically, those skilled in the art may also refer to the windshield 11 as “windshield glass”.

In some embodiments, the windshield 11 may be disposed to be inclined in the vehicle longitudinal direction and may be connected to a front part of the cowl top panel 21 through a windshield sealer.

For example, in some embodiments, the windshield 11 may include glass 15 coated with an opaque film 13 at an edge part. The configuration and mounting structure of the windshield 11 may be apparent to those skilled in the art, and thus detailed descriptions thereof will be omitted.

In some embodiments, the cowl lower panel 23 may be disposed below the cowl top panel 21 at a set distance from the cowl top panel 21. The cowl lower panel 23 may be connected to the dash panel 10.

In some embodiments, the cowl lower reinforcement panel 25 may be configured to reinforce the cowl stiffness of the cowl lower panel 23. The cowl lower reinforcement panel 25 may be connected to a front part of the cowl lower panel 23. A part such as a wiper device may be mounted on the cowl lower reinforcement panel 25, for example.

In some embodiments, the cowl lower reinforcement panel 25 may be bolt-connected to the front part of the cowl lower panel 23 in the vehicle longitudinal direction by a fastening member 35, such as a bolt 31, a nut 33, etc.

In some embodiments, the at least one bulkhead 27 may be configured to reinforce the connecting stiffness of the cowl top panel 21 and the cowl lower panel 23. The at least one bulkhead 27 may be connected between the cowl top panel 21 and the cowl lower panel 23.

For example, in some embodiments, the at least one bulkhead 27 may be provided in a pair. The pair of bulkheads 27 may be respectively disposed on both sides along the vehicle width direction between the cowl top panel 21 and the cowl lower panel 23.

A cowl cross reinforcement member 19 is shown in FIG. 4. In some embodiments, the cowl cross reinforcement member 19 may be configured to reinforce the stiffness of the dash panel 10. The cowl cross reinforcement member 19 may be connected to a rear surface of the dash panel 10 at a position corresponding to the cowl lower panel 23 and the cowl lower reinforcement panel 25.

Referring to FIGS. 1-4 , in some embodiments, the VIN unit 50 may be configured to position the vehicle identification number on the front cowl assembly 20.

In some embodiments, the VIN unit 50 may be disposed inside the windshield 11 and may be connected to one upper side of the front cowl assembly 20.

In some embodiments, the inner side may be defined as toward the interior of the front cabin 9 based on the windshield 11. In some embodiments, the one side as described above may be defined as right or left based on the seating position of the driver.

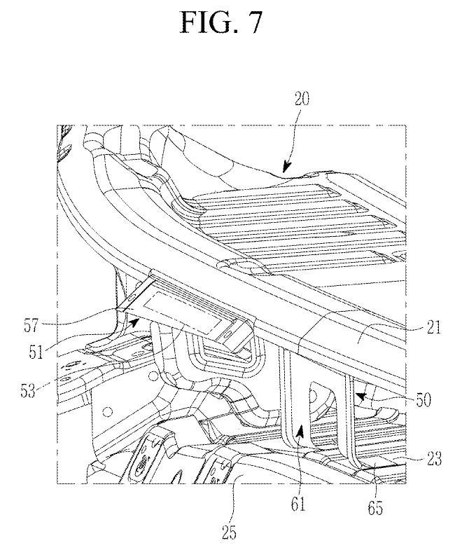

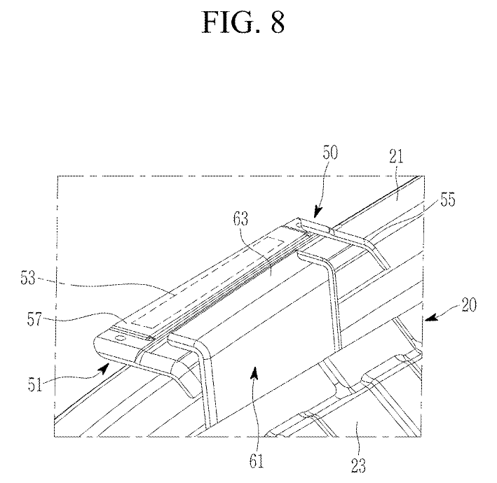

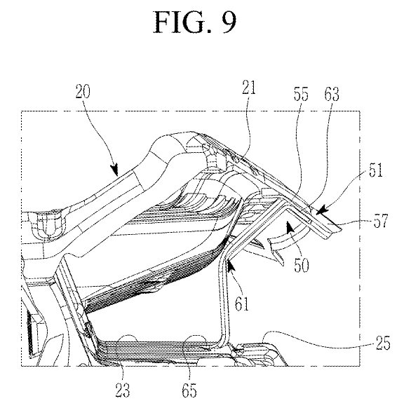

FIGS. 7 and 8 are perspective views showing a VIN unit applied to a front vehicle body structure according to a disclosed example embodiment. FIG. 9 is a side view showing a VIN unit applied to a front vehicle body structure according to a disclosed example embodiment.

Referring to FIGS. 1-4, and 7-9 in some embodiments, the VIN unit 50 may include a VIN engraving bracket 51 and a cowl connection reinforcement bracket 61.

In some embodiments, the VIN engraving bracket 51 may be connected to the cowl top panel 21 of the front cowl assembly 20. The VIN engraving bracket 51 may include a VIN engraving part 53 formed at a position corresponding to the lower part of the windshield 11.

In some embodiments, the VIN engraving bracket 51 may be connected to a front lower part of the cowl top panel 21. The VIN engraving bracket 51 may extend from the front lower part of the cowl top panel 21 in the inclined direction of the windshield 11. The VIN engraving part 53 may be formed on an extending portion of the VIN engraving bracket 51.

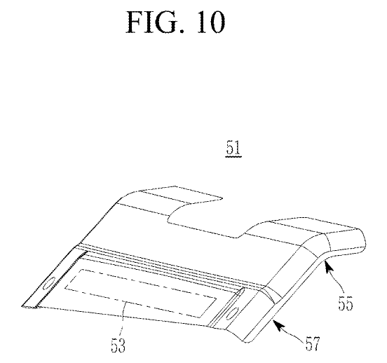

FIG. 10 is a perspective view showing a VIN engraving bracket of a VIN unit applied to a front vehicle body structure according to a disclosed example embodiment.

As illustrated in FIG. 10, in some embodiments, the VIN engraving bracket 51 may include a first portion 55 and a second portion 57.

In some embodiments, the first portion 55 may be connected to the front lower part of the cowl top panel 21. The second portion 57 may extend from the first portion 55 along the inclined direction of the windshield 11.

In some embodiments, the VIN engraving part 53 may be formed on the second portion 57. The VIN engraving part 53 may be engraved on the second portion 57 by a laser engraving device, for example.

In some embodiments, the cowl connection reinforcement bracket 61 may connect the cowl top panel 21 and the cowl lower panel 23 along the vertical direction, and may be configured to strengthen the connecting stiffness of the cowl top panel 21 and the cowl lower panel 23 and the connecting stiffness of the VIN engraving bracket 51.

In some embodiments, the cowl connection reinforcement bracket 61 may be connected to the VIN engraving bracket 51 and may be connected to the upper part of the cowl lower panel 23.

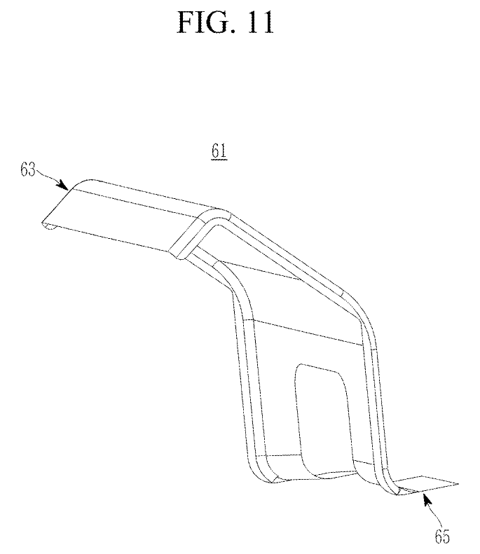

FIG. 11 is a perspective view showing a cowl connection reinforcement bracket of a VIN unit configured to be applied to a front vehicle body structure according to a disclosed example embodiment.

In some embodiments, the cowl connection reinforcement bracket 61 may be provided in a “Z” cross-sectional shape, for example. As illustrated in FIG. 11, such a cowl connection reinforcement bracket 61 may include an upper connecting portion 63 formed at an upper part and a lower connecting portion 65 formed at a lower part.

In some embodiments, the upper connecting portion 63 may be connected to the first portion 55 of the VIN engraving bracket 51. In some embodiments, the front part of the cowl top panel 21, the first portion 55 of the VIN engraving bracket 51, and the upper connecting portion 63 may be connected in three layers along the vertical direction by a triple-layer weld 67, as illustrated in FIG. 4 for example. As illustrated in FIG. 4, in some embodiments, the VIN engraving bracket 51 may be sandwiched between the cowl top panel 21 and the upper connecting portion 63 of the cowl connection reinforcement bracket 61 at the location of the triple-layer weld 67, with the cowl top panel 21 being on top and with the second portion 57 extending to beyond the cowl top panel 21 such that the cowl top panel 21 is not covering the VIN engraving part 53 on the second portion 57 of the VIN engraving bracket 51.

In some embodiments, the lower connecting portion 65 may be connected to the upper part of the cowl lower panel 23. In some embodiments, the cowl lower panel 23 and the lower connecting portion 65 may be connected in two layers along the vertical direction by a double-layer weld 69, as illustrated in FIG. 4 for example.

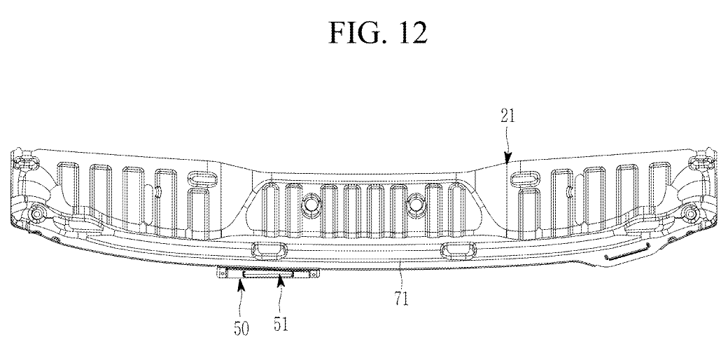

FIG. 12 is a view showing a windshield sealer application line applied to a front vehicle body structure according to a disclosed example embodiment.

In some embodiments, as the first portion 55 of the VIN engraving bracket 51 is connected to the front lower part of the cowl top panel 21, a windshield sealer application line 71 may be formed on the front upper part of the cowl top panel 21, as illustrated in FIG. 12 for example.

In some embodiments, the windshield sealer application line 71 may be formed along the vehicle width direction on the front upper part of the cowl top panel 21. A windshield sealer for connecting the windshield 11 to the front part of the cowl top panel 21 may be applied to the windshield sealer application line 71.

Accordingly, in some embodiments, as the VIN engraving bracket 51 may be connected to the front lower part of the cowl top panel 21 and the windshield sealer application line 71 may be formed on the front upper part of the cowl top panel 21, the sealer application process can be smoothly performed without being hindered by the VIN engraving bracket 51.

Referring to FIGS. 2-4 , in some embodiments, the VIN engraving part 53 of the VIN engraving bracket 51 may be exposed to the outside through a slit 73 formed along the vehicle width direction in the opaque film 13 coated on the lower part of the windshield 11.

In some embodiments, the lower part of the windshield 11 may be provided as a protective cover 75 that protects the VIN engraving part 53 while exposing the VIN engraving part 53 to the outside through the slit 73.

Next, an example assembly process and operation of the front vehicle body structure 100 according to some example embodiments of the present disclosure will be described in detail with reference to FIGS. 1-12 .

In some embodiments, the cowl top panel 21 and the cowl lower panel 23 of the front cowl assembly 20 may be connected to the dash panel 10. At least one bulkhead 27 may be connected between the cowl top panel 21 and the cowl lower panel 23.

In some embodiments, the cowl lower reinforcement panel 25 of the front cowl assembly 20 may be provided in a state separated from the cowl lower panel 23.

In some embodiments, the VIN unit 50 including the VIN engraving bracket 51 and the cowl connection reinforcement bracket 61 may be provided.

In some embodiments, the windshield 11 in which the opaque film 13 is coated on an edge part of the glass 15 may be provided.

In this state, in some embodiments, a process of assembling the VIN engraving bracket 51 and the cowl connection reinforcement bracket 61 of the VIN unit 50 to the front cowl assembly 20 may be performed.

In the above example process, the first portion 55 of the VIN engraving bracket 51 may be connected to the front lower part of the cowl top panel 21. The second portion 57 of the VIN engraving bracket 51 may extend from the first portion 55 along the inclined direction of the windshield 11 and may protrude from the front end of the cowl top panel 21.

The upper connecting portion 63 of the cowl connection reinforcement bracket 61 may be connected to the first portion 55 of the VIN engraving bracket 51. The lower connecting portion 65 of the cowl connection reinforcement bracket 61 may be connected to the upper part of the cowl lower panel 23.

In some embodiments, the front part of the cowl top panel 21, the first portion 55 of the VIN engraving bracket 51, and the upper connecting portion 63 may be connected by welding along the vertical direction. That is, in some embodiments, the front part of the cowl top panel 21, the first portion 55 of the VIN engraving bracket 51, and the upper connecting portion 63 may be connected to each other along the vertical direction by the triple-layer weld 67. In some embodiments, the lower connecting portion 65 and the upper part of the cowl lower panel 23 may be connected by welding along the vertical direction. That is, in some embodiments, the lower connecting portion 65 and the cowl lower panel 23 may be connected to each other along the vertical direction by the double-layer weld 69.

In some embodiments, the assembly processes as described above may be performed, for example, in a vehicle body assembly line that assembles the vehicle body 1 in a body-in-white (BIW) state. In some embodiments, the vehicle body 1 assembled in the vehicle body assembly line may be transferred to an interior assembly line.

In the interior assembly line, for some embodiments, the cowl lower reinforcement panel 25 may be bolt-connected to the front part of the cowl lower panel 23 in the vehicle longitudinal direction by the fastening member 35. That is, in some embodiments, the cowl lower reinforcement panel 25 may not be connected to the cowl lower panel 23 by welding in the vehicle body assembly line, but may be bolt-connected to the cowl lower panel 23 in the interior assembly line.

In some embodiments, the reason why such a process may be performed is that the PE room of the front body module 5 may be narrow, making it not easy to weld and join the cowl lower reinforcement panel 25 to the cowl lower panel 23 in the vehicle body assembly line.

In some embodiments, the cowl connection reinforcement bracket 61 may be provided in a “Z” cross-sectional shape, and interference between the cowl connection reinforcement bracket 61 and the cowl lower reinforcement panel 25 may be avoided when mounting and removing the cowl lower reinforcement panel 25.

In some embodiments, a process of engraving a vehicle identification number on the second portion 57 of the VIN engraving bracket 51 may be performed.

For example, for some embodiments in the above process, the vehicle identification number may be engraved on the second portion 57 by a laser engraving device. Accordingly, in some embodiments, the VIN engraving part 53 in which the vehicle identification number is engraved may be formed on the second portion 57.

In some embodiments, in a state where the second portion 57 is exposed to the outside, the vehicle identification number may be engraved on the second portion 57. Therefore, in some embodiments, the engraving work and finishing work of the vehicle identification number may become easy.

In some embodiments, because the cowl connection reinforcement bracket 61 is connected to the VIN engraving bracket 51, the VIN engraving bracket 51 may support the load of a relatively heavy laser engraving device. Therefore, in some embodiments, engraving defects of the VIN engraving bracket 51 may be minimized, and the workability of the engraving process may be improved.

In some embodiments, a process of assembling the windshield 11 to the cowl top panel 21 of the front cowl assembly 20 may be performed.

For some embodiments in the above process, in a state where the VIN engraving bracket 51 is disposed at the front lower part of the cowl top panel 21, the windshield sealer may be applied on the front upper part of the cowl top panel 21 along the windshield sealer application line 71 in the vehicle width direction.

Therefore, in some embodiments, because the windshield sealer application process may be performed without being hindered by the VIN engraving bracket 51, the assemblability of the windshield 11 may be improved (e.g., because the windshield sealer application line 71 may be above the VIN engraving bracket 51 and spaced apart from the VIN engraving part 53).

In some embodiments, the windshield 11 may be disposed to be inclined in the vehicle longitudinal direction and may be connected to the front part of the cowl top panel 21 through the windshield sealer.

In some embodiments, the windshield 11 may include the slit 73 formed along the vehicle width direction in the opaque film 13 at a position corresponding to the VIN engraving part 53 of the VIN engraving bracket 51.

Therefore, in some embodiments, the VIN engraving part 53 may be exposed to the outside through the slit 73 while being covered and protected by the windshield 11.

In some embodiments, a process of mounting interior parts on the cowl lower reinforcement panel 25 may be performed.

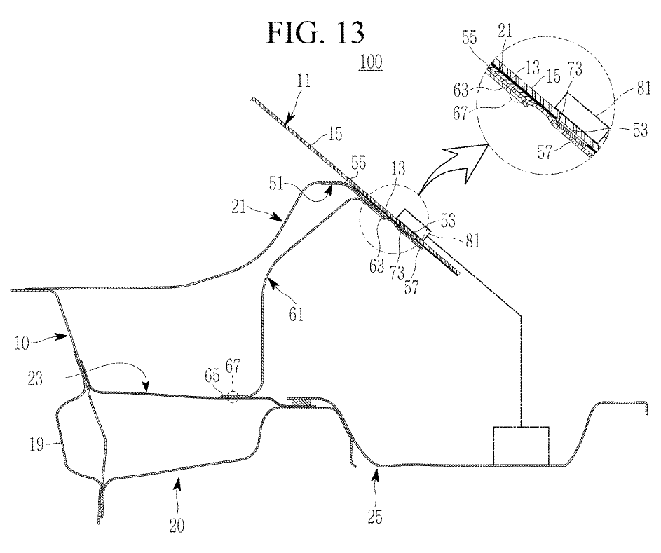

FIG. 13 is a view for explaining an operation of a front vehicle body structure according to a disclosed example embodiment.

For example, in the above process, as illustrated in FIG. 13, a wiper part 81 of a wiper device may be mounted on the cowl lower reinforcement panel 25.

In some embodiments, the slit 73 may be covered by the wiper part 81. The wiper part 81 may cover the VIN engraving part 53 exposed to the outside through the slit 73.

According to the front vehicle body structure 100 assembled through the assembly processes as described above, in some embodiments, the VIN engraving bracket 51 on which the vehicle identification number is engraved may be mounted on the front cowl assembly 20 of the front body module 5.

That is, in some embodiments, the vehicle identification number is not located on the rear body module 7 as the replaceable portion 7a that may be replaced according to the purpose of use of the PBV, but the vehicle identification number may be located on the front body module 5 as the fixed portion 5a that is not replaced even if the purpose of use of the PBV is changed.

Therefore, according to the front vehicle body structure 100 according to some embodiments, as the vehicle identification number is located on the front cowl assembly 20 of the front body module 5 which is not replaced even if the purpose of use of the PBV is changed, combined production according to the specification of the vehicle body is possible, and the specification scalability of the body may be secured.

The front vehicle body structure 100 according to the some embodiments may satisfy the requirement of a regulation that the vehicle identification number must be engraved on a vehicle body structure that is not detachable in order to prevent forgery and tampering of the vehicle identification number.

According to the front vehicle body structure 100 according to some embodiments, the VIN engraving part 53 of the VIN engraving bracket 51 may be covered by the wiper part 81 under normal circumstances. In some embodiments, when the wiper part 81 is lifted, the VIN engraving part 53 may be exposed to the outside through the slit 73 of the windshield 11.

Accordingly, the front vehicle body structure 100 according to some embodiments may satisfy the legal requirement (or regulatory matter) that visibility of the vehicle identification number must be secured.

According to the front vehicle body structure 100 according to some embodiments, as the lower part of the windshield 11 is provided as a protective cover 75 that protects the VIN engraving part 53, it is possible to prevent, or make more difficult, forgery and tampering of the vehicle identification number due to vehicle theft.

Furthermore, according to the front vehicle body structure 100 according to some embodiments, the cowl connection reinforcement bracket 61 may be connected to the VIN engraving bracket 51. In some embodiments, the cowl connection reinforcement bracket 61 may be connected to the cowl top panel 21 and the cowl lower panel 23 of the front cowl assembly 20 through the VIN engraving bracket 51.

Therefore, the front vehicle body structure 100 according to some embodiments may secure connectivity between the front cowl assembly 20 and the VIN engraving bracket 51, and may strengthen the connecting stiffness of the front cowl assembly 20 and the VIN engraving bracket 51.

While some disclosed example embodiments have been described above, the present disclosure is not necessarily limited thereto, and various modifications for other embodiments can be made within the scopes of the claims and equivalents thereof.

What is claimed is:

1. A front vehicle body structure comprising:
a dash panel;
a windshield;
a front cowl assembly connected to the dash panel; and
a vehicle identification number (VIN) unit disposed inside the windshield and connected to an upper part of the front cowl assembly.

2. The front vehicle body structure of claim 1, wherein the front cowl assembly comprises:
a cowl top panel connected to an upper part of the dash panel; and
a cowl lower panel disposed below the cowl top panel and connected to the dash panel.

3. The front vehicle body structure of claim 2, wherein the VIN unit comprises a VIN engraving bracket connected to the cowl top panel, wherein the VIN engraving bracket includes a VIN engraving part disposed at a position corresponding to a lower part of the windshield.

4. The front vehicle body structure of claim 3, wherein the VIN engraving bracket is connected to a lower part of the cowl top panel and extends from the lower part of the cowl top panel in an inclined direction of the windshield.

5. The front vehicle body structure of claim 3, wherein the VIN engraving bracket extends from the lower part of the cowl top panel in an inclined direction of the windshield, and
wherein the VIN engraving part is on an extending portion of the VIN engraving bracket.

6. The front vehicle body structure of claim 3, further comprising an opaque film coated on a lower edge of the windshield along a vehicle width direction, wherein the opaque film includes a slit opening, and wherein the VIN engraving part is aligned with the slit opening such that the VIN engraving part is visibly to outside through the slit opening and through the windshield.

7. The front vehicle body structure of claim 3, further comprising:
an opaque film coated on a lower edge of the windshield along a vehicle width direction, wherein the opaque film includes a slit opening, and wherein the VIN engraving part is aligned with the slit opening such that the VIN engraving part is visibly to outside through the slit opening and through the windshield;
a cowl lower reinforcement panel connected to the cowl lower panel; and
a wiper device mounted on the cowl lower reinforcement panel, wherein at least part of the wiper device covers the slit opening.

8. The front vehicle body structure of claim 2, wherein the VIN unit comprises:
a VIN engraving bracket connected to the cowl top panel, wherein the VIN engraving bracket includes a VIN engraving part disposed at a position corresponding to a lower part of the windshield; and
a cowl connection reinforcement bracket connected to the VIN engraving bracket and connected to an upper part of the cowl lower panel.

9. The front vehicle body structure of claim 8, wherein the VIN engraving bracket comprises:
a first portion connected to the lower part of the cowl top panel and the cowl connection reinforcement bracket by triple-layer welding; and
a second portion extending from the first portion along an inclined direction of the windshield and wherein the VIN engraving part is on the second portion of the VIN engraving bracket.

10. The front vehicle body structure of claim 8, wherein the cowl connection reinforcement bracket includes a “Z” cross-sectional shape.

11. The front vehicle body structure of claim 8, wherein the VIN engraving bracket is connected to the lower part of the cowl top panel, and
wherein the cowl top panel includes a windshield sealer application line extending along a vehicle width direction on the upper part of the cowl top panel.

12. The front vehicle body structure of claim 2, wherein the front cowl assembly further comprises:
a cowl lower reinforcement panel connected to the cowl lower panel; and
a bulkhead connected between the cowl top panel and the cowl lower panel.

13. The front vehicle body structure of claim 12, wherein the cowl lower reinforcement panel is bolt-connected to the cowl lower panel and wherein the cowl lower reinforcement panel is extending in a vehicle longitudinal direction from the cowl lower panel.

14. The front vehicle body structure of claim 1, wherein the front cowl assembly comprises:
a cowl top panel connected to an upper part of the dash panel, and
a cowl lower panel disposed below the cowl top panel and connected to the dash panel; and
wherein the VIN unit comprises:
a cowl connection reinforcement bracket extending vertically between the cowl top panel and the cowl lower panel, and
a VIN engraving bracket comprising:
a first portion sandwiched between the cowl top panel and the cowl connection reinforcement bracket, wherein the cowl top panel is on top of the first portion of the VIN engraving bracket, and wherein the cowl top panel, the cowl connection reinforcement bracket, and the first portion of the VIN engraving bracket are triple-welded together, and
a second portion extending from the first portion beyond the cowl top panel such that the second portion is not covered by the cowl top panel, wherein the second portion includes a VIN engraving part.

15. A vehicle structured as a purpose built vehicle (PBV) comprising:
a front body module that is permanently fixed at a front part of the vehicle, wherein the front body module comprises:
a dash panel,
a windshield,
a front cowl assembly connected to the dash panel, and
a vehicle identification number (VIN) unit disposed inside the windshield and connected to an upper part of the front cowl assembly; and
a rear body module configured as a replaceable portion selectively couplable with the front body module, wherein the rear body module is at a rear part of the vehicle.

16. The vehicle of claim 15, wherein the front cowl assembly comprises:
a cowl top panel connected to an upper part of the dash panel, and
a cowl lower panel disposed below the cowl top panel and connected to the dash panel; and
wherein the VIN unit comprises:
a cowl connection reinforcement bracket extending vertically between the cowl top panel and the cowl lower panel, and
a VIN engraving bracket comprising:
a first portion sandwiched between the cowl top panel and the cowl connection reinforcement bracket, wherein the cowl top panel is on top of the first portion of the VIN engraving bracket, and wherein the cowl top panel, the cowl connection reinforcement bracket, and the first portion of the VIN engraving bracket are triple-welded together, and
a second portion extending from the first portion beyond the cowl top panel such that the second portion is not covered by the cowl top panel, wherein the second portion includes a VIN engraving part.

17. The vehicle of claim 16, wherein the front cowl assembly further comprises an opaque film coated on a lower edge of the windshield along a vehicle width direction, wherein the opaque film includes a slit opening, and wherein the VIN engraving part is aligned with the slit opening such that the VIN engraving part is visibly to outside through the slit opening and through the windshield.

18. The vehicle of claim 17, wherein the front cowl assembly further comprises:
two bulkheads connected between the cowl top panel and the cowl lower panel, wherein the two bulkheads are spaced apart from each other in a vehicle wide direction;
a cowl lower reinforcement panel connected to the cowl lower panel and extending towards a front end of the vehicle; and
a wiper device mounted on the cowl lower reinforcement panel, wherein at least part of the wiper device covers the slit opening.

19. A vehicle comprising:
a dash panel;
a front cowl assembly connected to a front side of the dash panel, wherein the front cowl assembly comprises:
a cowl top panel connected to an upper part of the dash panel, and
a cowl lower panel disposed below the cowl top panel and connected to the front side of the dash panel;
a windshield connected to the front cowl assembly;
a vehicle identification number (VIN) structure disposed under the windshield and connected to the front cowl assembly, wherein the VIN structure comprises:
a cowl connection reinforcement bracket extending vertically between the cowl top panel and the cowl lower panel, wherein a lower portion of the cowl connection reinforcement bracket is welded to the cowl lower panel, and
a VIN engraving bracket comprising:
a first portion sandwiched between the cowl top panel and an upper portion of the cowl connection reinforcement bracket, wherein the cowl top panel is on top of the first portion of the VIN engraving bracket, and wherein the cowl top panel, the upper portion of the cowl connection reinforcement bracket, and the first portion of the VIN engraving bracket are triple-welded together, and
a second portion extending from the first portion beyond the cowl top panel such that the second portion is not covered by the cowl top panel, wherein the second portion includes a VIN engraving part; and
an opaque film coated on a lower edge of the windshield along a vehicle width direction, wherein the opaque film includes a slit opening, and wherein the VIN engraving part is aligned with the slit opening such that the VIN engraving part is visibly to outside through the slit opening and through the windshield.

20. The vehicle of claim 19, wherein the vehicle is configured as a purpose built vehicle (PBV) comprising:
a front body module permanently fixed at a front part of the vehicle; and
a rear body module configured as a replaceable portion removably couplable with the front body module, wherein the rear body module is removably coupled at a rear part of the vehicle,
wherein the front body module comprises the dash panel, the front cowl assembly, the windshield, the opaque film, and the VIN structure.
